(19) United States
(12) Patent Application Publication
(10) Pub. No.: US 2013/0197940 A1
(43) Pub. Date: Aug. 1, 2013

(54) System for Automated Health Information Exchange

(71) Applicant: Reliant Medical Group, Inc., Worcester, MA (US)

(72) Inventor: Lawrence D. Garber, Southborough, MA (US)

(73) Assignee: Reliant Medical Group, Inc., Worcester, MA (US)

(21) Appl. No.: 13/750,061

(22) Filed: Jan. 25, 2013

Related U.S. Application Data
(60) Provisional application No. 61/591,027, filed on Jan. 26, 2012.

(51) Int. Cl. G06F 19/00; G06Q 50/24

(52) U.S. Cl. CPC G06F 19/322; G06Q 50/24
USPC 705/3

(57) ABSTRACT

In one arrangement of a system for automated health information exchange, each server is configured to receive patient encounter information from corresponding entities. The patient encounter information includes affiliation information that identifies a patient's affiliation with one or more health care entities of a group of health care entities. Once received, the server reviews the affiliation information to identify other facilities that have provided, or are about to provide, care to the patient. The server establishes and maintains a link, such as a network link, with each of these other entities identified in the patient encounter information. Based upon the links and patient authorizations, the server can automatically retrieve the patient's electronic patient records from the other facilities' servers and forward the records to its corresponding entity, or automatically send the patient's electronic patient records to the linked facilities' servers.

### RELATED APPLICATIONS

This patent application claims the benefit of U.S. Provisional Application No. 61/591,027, filed on Jan. 26, 2012, entitled, “System for Consent-Enabled Automated Health Information Exchange,” the contents and teachings of which are hereby incorporated by reference in their entirety.

### BACKGROUND

Causes of poor quality healthcare can be linked to data, information, or knowledge that is inaccessible at the moment and location that it could have helped in decision making or treatment. Missing data and lack of data access can impede the delivery of high quality healthcare services. For example, not having the necessary information available when and where it's needed is not merely inconvenient to the patient and health care provider, but it diminishes the quality and safety of care and raises health care costs.

To improve the delivery of healthcare services, certain health care providers, such as hospitals and physicians, have implemented the use of electronic health records (EHRs). For example, many states are developing electronic Health Information Exchanges (HIEs) centered around Health Information Service Providers (HISPs). The HISPs deploy provider and patient “mailboxes” or servers that are capable of using the Direct Project's protocols to send and receive clinical information from where it originated to where it is needed in a substantially secure manner.

### SUMMARY

State implemented HIEs can utilize email-like secure messaging for the exchange of electronic patient records (EPRs) among healthcare entities with EHRs and can allow for entities to electronically query other entities for copies of their patient information. However, busy physicians do not typically look beyond information that is directly presented to them during a visit and thus are unlikely to consistently take the time to use query-capabilities. Additionally, conventional HIEs require the health care entities to manually trigger individual messages through the HIEs to every member of a patient's care team in order to update them on changes in a patient's status. Such requirement can be burdensome to a busy physician and staff. Furthermore, conventional HIEs require the patient to sign multiple consent forms prior to allowing a healthcare entity to manually update the patient's medical records or status with their other healthcare providers. Such requirements can be burdensome to the patient who has to provide the authorizations, and the staff that have to obtain them.

By contrast to conventional health information exchanges, embodiments of the present innovation relate to a system for automated health information exchange. In one arrangement, each server, such as virtually integrated proxy servers (VIP) of an automated health information exchange system, is configured to automatically receive all patient encounter information associated with a patient from corresponding facilities. The patient encounter information can be generated following any contact with, or about, the patient and can include registration information, orders, referrals, billing claims, or authorizations for releasing medical records. The patient encounter information can also include other sources of clinical information or affiliation information that identifies the patient's affiliation with one or more health care entities of a group of health care entities, such as a primary health provider facility, a specialist facility, an acute-care facility, a long term or post-acute care entity, an ancillary entity, or a healthcare payer entity. Once received, each server reviews the affiliation information to identify other facilities that have provided, or are about to provide, care to the patient. Each server establishes and maintains a link, such as a network link, with each of these other facilities identified in the patient encounter information.

In one arrangement, embodiments of the innovation relate to, in a server device associated with a first patient care entity of a group of patient care entities, a method for associating electronic health records among the patient care entities. The method includes receiving, by the server associated with the first patient care entity, patient encounter information associated with a patient of the first patient care entity. The method includes reviewing, by the server associated with the first patient care entity, affiliation information of the patient encounter information, the affiliation information identifying the patient's affiliation with one or more second patient care entities of the group of patient care entities. The method includes establishing, by the server associated with the first patient care entity, a link with each of the identified one or more second patient care entities of the group of patient care entities based upon the affiliation information, the link identifying an association between the first patient care entity and the one or more second patient care entities for the patient.

In one arrangement, each server of the automated health information exchange system is configured with rules to automatically query for information from the patient's other authorized healthcare providers. For example, a server can automatically query for patient information (e.g., electronic health records) from other linked servers (i.e., servers of facilities associated with and authorized by the patient) at the moment a new affiliation is identified or a new encounter occurs. Based upon patient consent, the network-linked server receives the patient's electronic health records from the other entitys' servers and forwards the records to its corresponding entity using a secure communication protocol, such as via a Direct message.

In one arrangement, each server of the automated health information exchange system is configured with rules to keep information automatically synchronized between the patient's authorized healthcare providers. For example, a server can automatically forward patient information (e.g., electronic health records) to other linked servers (i.e., servers of entities associated with and authorized by the patient) at the moment that the records are created or modified. Such automatic forwarding to the other linked servers can be based upon the server having previously received client consent to forward the patient information to one or more of the linked servers

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 illustrates a schematic representation of an automated health information exchange system, according to one arrangement.

FIG. 2 illustrates a schematic representation of a first server device and a second server device of the system of FIG. 1, according to one arrangement.

FIG. 3 illustrates a schematic representation of the automated health information exchange system of FIG. 1 interacting with an enumeration server, according to one arrangement.

FIG. 4 illustrates a schematic representation of a first server device, a second server device, and a third server device of the system of FIG. 3, according to one arrangement.

FIG. 5 illustrates a schematic representation of a first server device, a second server device, and a third server device of the system of FIG. 3, according to one arrangement.

FIG. 6 illustrates a schematic representation of a server device of the system of FIG. 3, according to one arrangement.

### DETAILED DESCRIPTION

Embodiments of the present innovation relate to a system for consent-enabled automated health information exchange. In one arrangement, each server, such as virtually integrated proxy server (VIP) of an automated health information exchange system, is configured to receive patient encounter information from corresponding entities. The patient encounter information include clinical information and affiliation information that identifies the patient's affiliation with one or more health care entities of a group of health care entities, such as a primary health provider entity, a specialist entity, an acute-care facility, a long term or post-acute care entity, an ancillary entity, or a healthcare payer entity. Once received, the server reviews the affiliation information to identify other entities that have provided, or are about to provide, care to the patient. The server establishes and maintains a link, such as a network link, with each of these other entities identified in the patient encounter information. Based upon patient consent, the network-linked server exchanges the patient's electronic health records with the other entities' servers and exchanges the records with its corresponding entity using a secure communication protocol, such as via a Direct message.

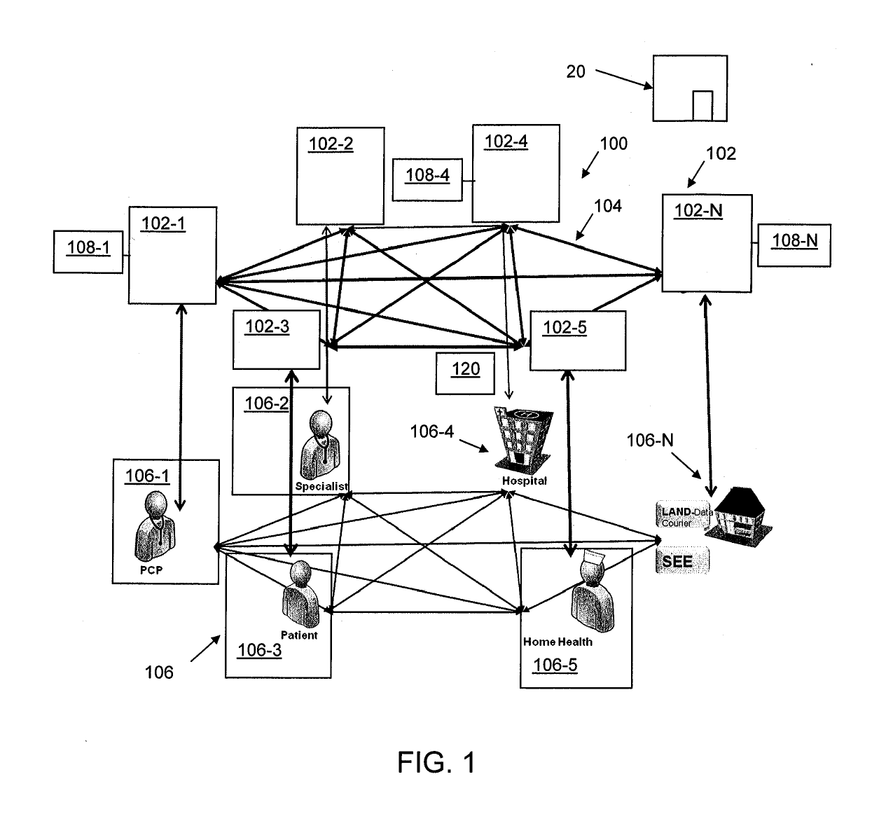

FIG. 1 illustrates a schematic representation of an automated health information exchange system 100, according to one arrangement. The system 100 includes a set of server devices or servers 102-1 through 102-N, collectively 102, disposed in electrical communication therewith via a network 104. In one arrangement, one or more of the servers 102 are configured as distinct hardware or computerized devices, each having a controller, such as a processor and memory. Alternately, one or more of the servers 102 are configured as virtual servers on a single hardware device. For example, each server 102 can be configured as a virtually integrated proxy server on a single hardware device.

In one arrangement, the controller of each server 102 stores an electronic health records association application that, when executed by the controller, causes the controller to perform the operation of linking health care entities 106 identified in patient encounter information 120 received from the entities 106. The electronic health records association application installs on each controller from a computer program product 20 as shown in FIG. 1. In certain arrangements, the computer program product 20 is available in a standard off-the-shelf form such as a shrink wrap package (e.g., CD-ROMs, diskettes, tapes, or flash drives). In other arrangements, the computer program product 20 is available in a different form (e.g., propagated signals, a network installation, or downloadable online media). In still other arrangements, the computer program product 20 is part of a storage medium contained within each server 102 as part of a memory from which such software may be loaded.

The automated health information exchange system 100 is configured to utilize a secure messaging protocol when exchanging messages among the servers 102-1 through 102-N. For example, each server 102 can be configured as a health information service provider mailbox or virtually integrated proxy server (VIP) mailbox to send and receive messages among the other servers 102 in the system 100 using Direct messaging (i.e., Direct Project HISP routing and secure messaging services).

As indicated in FIG. 1, a number of health care entities 106 (e.g., computerized devices such as electronic health records or other computer systems associated with each entity) can interact with the health information exchange system 100 such that each health care entity 106-1 through 106-N has its own corresponding dedicated server 102-1 through 102-N. For example, a primary care professional (PCP) entity 106-1 interacts with a dedicated first server 102-1, a specialist entity 106-2 interacts with a dedicated second server 102-2, a patient entity 106-3 interacts with a dedicated third server 102-3, a hospital facility interacts with a dedicated fourth server 102-4, a home healthcare entity 106-5 interacts with a dedicated fifth server 102-5, a nursing entity 106-N configured with Surrogate Electronic Health Record Environment (SEE) which simulates electronic health record functionality, and a Local Application for Network Distribution (LAND), which acts as a data courier to gather and securely transfer electronic data, interacts with a dedicated server 102-N.

The health care entities 106-1 through 106-N utilize a secure messaging protocol when exchanging messages with the corresponding dedicated servers 102-1 through 102-N. For example, health care entities 106-1 through 106-5 can be configured to send messages to the corresponding dedicated servers 102-1 through 102-5 using a secure communication protocol, such as Direct Simple Mail Transfer Protocol/Simple Multipurpose Internet Mail Extensions (SMTP/SMIME) messaging while health care entity 106-N can be configured to send messages to the corresponding dedicated server 102-N using LAND with IHE XDR SOAP protocols.

The automated health information exchange system 100 is configured to send and/or retrieve and update a patient's medical records among all associated health care entities or entities 106 that provide health services to the patient. For example, assume a patient visits the PCP entity 106-1 annually for a physical examination. Accordingly, the PCP entity 106-1 retains and stores the patient's electronic medical records. Further assume the case where the patient visits the hospital facility 106-4, for the first time, to receive emergency medical care. By utilizing the automated health information exchange system 100, the hospital facility 106-4 that records the name of the PCP from the patient, can identify the PCP entity 106-1 as retaining the patient's electronic medical records and can automatically and electronically retrieve the patient records from the PCP entity 106-1. Similarly in the same example, utilizing the automated health information exchange system 100, the hospital facility 106-4 that records the name of the PCP from the patient, can automatically and electronically send the hospital's encounter summary records to the PCP entity 106-1. Using knowledge about Referring and Referred-To providers, in conjunction with patient authorizations, each server (e.g., VIP mailbox) 102 can identify the appropriate recipient of copies of, for example, CCDs and UTFs, and facilitate these transactions. An example regarding the operation of the system 100 is provided below.

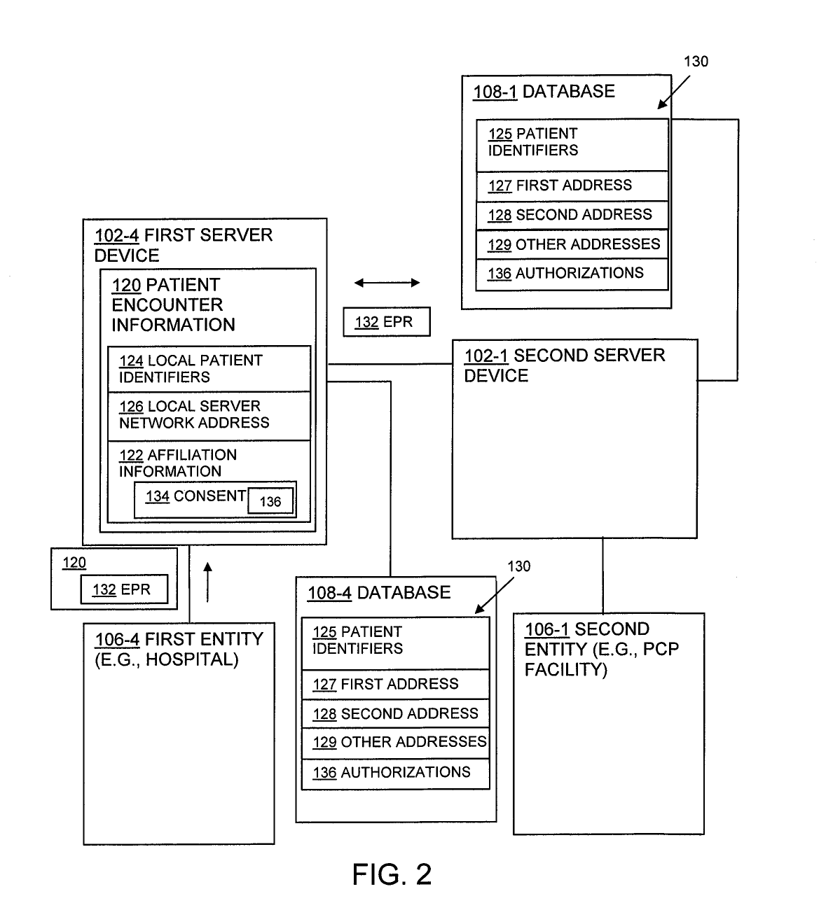

With reference to FIG. 2, in order to initiate the sending and/or retrieval process, a health care entity 106, such as the hospital facility 106-4, prepares or intakes patient encounter information 120. The patient encounter information 120 identifies the patient as well as the type of services to be provided, or were provided, to the patient. For example, the patient encounter information 120 can be configured as a Continuity of Care Document (CCD) or other Health Level 7 (HL7) Clinical Document Architecture (CDA)-based document, a patient referral (e.g., Universal Transfer Form (UTF)), a change in patient registration (e.g., an Admission/Discharge/Transfer (ADT) message), a medical order, a test result, a procedure report, a request or authorization for a release of medical information, a bill to a health insurance entity, or other message or document that identifies a facility, entity, or person that has a relationship to the patient. The patient encounter information 120 typically includes affiliation information 122 such as information that identifies the patient's affiliation with one or more health care entities of a group of health care entities 106. For example, ADT messages, patient referral, medical orders, and requests for a release of medical information typically include affiliation information 122 that identifies the location of the patient's PCP entity 106-1 and/or a specialist entity 106-2 that provides health services to the patient.

The patient encounter information 120 associates the patient with local patient identifiers 124, such as a local medical record number (MRN) and associated patient demographic information (e.g., name, aliases, date of birth, gender, addresses, phone numbers, etc.), as well as with the local providing (e.g., check in) entity, such as the hospital facility 106-4, and the associated network address 126, such as a VIP Direct address, of the hospital facility's server 102-4. In one arrangement, such association can be done automatically, such as when the patient encounter information 120 is configured as an ADT message or patient referral, or manually by the staff at the preparing entity 106-4. The patient encounter information 120 also includes a network address 128 of the other servers 102 in the network 104 associated with the patient. For example, the patient encounter information 120 can include a network address 128, such as a VIP Direct address, of the server 102-1 corresponding to patient's PCP entity 106-1 or of a referring provider, such as a VIP Direct address of the server 102-2 associated with the specialist entity 106-2 that referred the patient to the local providing entity (i.e., the hospital facility 106-4) for the current encounter. These “Referring” and “Referred-To” provider entities 106 allow for the establishment of linkages between treating provider entities 106 for a particular patient.

The provider entity, such as the hospital facility 106-4, can then transmit the patient encounter information 120 to its corresponding server 102-4 using a secure communication protocol. Each server 102 is configured to recognize the one or more source addresses that constitute their own entity. Accordingly, in one arrangement, the hospital facility 106-4 sends the patient encounter information 120 as a Direct message to the server 102-4 such that the patient encounter information 120 includes a source Direct email address identifying the entity, in this case the hospital 106-4 sending the message 120, and a receiver Direct email address 126 identifying the server 102-4 as the intended recipient of the message. With such a configuration, the server 102-4 can distinguish patient encounter information 120 received from its own associated entity 106-4, as sent to the server's network or VIP address, versus patient encounter information 120 received from an outside entity. Accordingly, the receiving server 102-4 can process the patient encounter information 120 using different rules and workflows than patient encounter information 120 received from the outside entities.

Once received and identified as coming from its own associated entity 106-4, the server 102-4 reviews the various fields in the patient encounter information 120, such as the affiliation information 122, to identify the patient's affiliation with one or more second patient care entities 106 (i.e., other entities that have provided care, or are about to provide care, to the patient). For example, assume the patient encounter information 120 is configured as an ADT that includes a network address 128 of the patient's PCP entity 106-1, such as a VIP Direct address of the server 102-1. As the server 102-4 reviews a network address field of the ADT for the patient, the server 102-4 can identify the network address 128 of the server 102-1 associated with the patient's PCP entity 106-1 and can similarly identify the PCP entity 106-1 as having provided healthcare treatment to the patient.

Following the review, the server 102-4 establishes a link with each identified second patient care entities 106 based upon the affiliation information 122, the link identifying an association between the first patient care entity 106-4 and the other patient care entities 106-2 for the patient. As shown in FIG. 2, the server 102-4 creates a link with the associated PCP entity server 102-1 for the patient identified by the patient encounter information 120. These linkages are stored as an entry 130, such as a Consent Authorizations Tied To Affiliations (CATTA) entry in a server-local database 108. For example, when creating the link, the server 102-4 can create an entry 130 in a server-local database 108-4 that associates the patient via patient identifiers 125 derived from local patient identifiers 124, such as the local medical record number (MRN) and associated patient demographic information (e.g., name, aliases, date of birth, gender, addresses, phone numbers, etc.), with both a server address 127 associated with the hospital facility 106-4 and with a server address 128 associated with the PCP entity 106-1. Accordingly, with such a link established between the entities, 106-1, 106-4, the server device 102-4 can utilize the link to exchange (i.e., send and/or receive) electronic patient records 132 with affiliated servers 102-1 for the particular patient. Similar links with additional affiliated entities 106 and their corresponding servers 102 can be accommodated by storing those server addresses as server addresses 129 in entry 130.

Electronic patient records 132 can be requested by server 102 from corresponding entity's electronic health record or other computer system associated with the entity. Alternatively, electronic patient records 132 can be pushed as they are generated in an entity's electronic health record or other computer system associated with the entity, to the entity's corresponding server 102. In one arrangement, electronic patient records 132 are contained within the patient encounter information 120. For example, the patient encounter information 120 can be configured as a Continuity of Care Document (CCD) or other HL7 Clinical Document Architecture (CDA)-based document, a patient referral (e.g., Universal Transfer Form (UTF)), a change in patient registration (e.g., an Admission/Discharge/Transfer (ADT) message), a medical order, a test result, a procedure report,a request or authorization for a release of medical information, a bill to a health insurance entity, or other message or document that also contains clinical information regarding the patient.

In one arrangement, to initiate the retrieval of electronic patient records from a source entity by a requesting entity, a server 102 first detects if the patient or their legal representative has given consent regarding transmittal or release of the electronic medical records. For example, with continued reference to FIG. 2, the server 102-4 reviews consent information 134 associated with the patient of the hospital facility 106-4.

The patient or their legal representative can provide consent information 134 either at the entity 106 that is requesting patient records, or at the other entities 106 affiliated with the patient. For example, with continued reference to FIG. 2, the patient can provide consent information 134 either at the current entity, such as the hospital facility 106-4 or at the other entities identified by the patient, such as in this case the PCP entity 106-1.

System 100 can simplify the identification of when a patient consent needs to captured and facilitate its capture. In one arrangement, if the server 102, or as in this example server 102-4, recognizes that no consent has been signed, or that there are one or more affiliated providers or healthcare entities yet insufficient patient authorization to exchange patient information with those entities, server 102-4 can trigger the printing of a consent form at the current entity, such as the hospital facility 106-4, offering the ability for the patient to provide consent to exchange information with those affiliated entities.

In one arrangement, the patient can provide a variety of levels of consent regarding the transfer of their electronic patient records 132. For example, the consent information 134 can identify that all of their healthcare providers, facilities or entities share records, they can let all except for certain entities share records, they can specifically chose certain entities to share records, or they can choose to not share any patient records. Furthermore, levels of consent can define which healthcare providers, facilities or entities can share what types of patient information with which healthcare providers, facilities or entities, for what purposes, and for what time periods.

After a patient provides, updates, or revokes authorization for release of their patient records, this information is then electronically sent from the entity 106 where it is obtained, to its corresponding server 102. In one arrangement, consent 134 is conveyed as part of patient encounter information 120. For example, patient encounter information 120 can be configured as a Continuity of Care Document (CCD) or other HL7 Clinical Document Architecture (CDA)-based document, a patient referral (e.g., Universal Transfer Form (UTF)), a change in patient registration (e.g., an Admission/Discharge/Transfer (ADT) message), a medical order, a test result, a procedure report, a request or authorization for a release of medical information, a bill to a health insurance entity, or other message or document that also contains patient authorization for release of patient records.

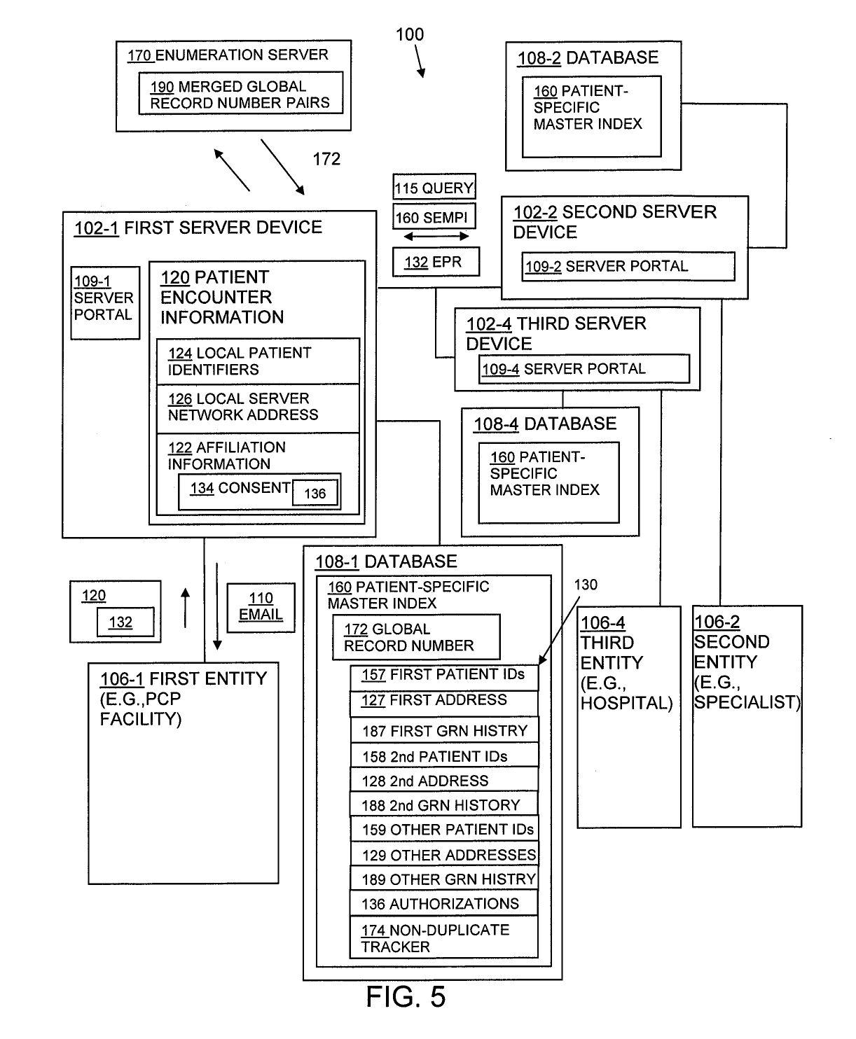

In one arrangement, with reference to FIG. 5, after a patient provides to an entity 106 authorization, revocation or updates to an authorization, for release of their patient records, a designee at that entity 106 with proper security can access that entity's corresponding server's 102 server portal 109. In this manner, server portal 109 can be used to directly enter the patient's authorizations as part of consent 134.

In one arrangement, the patient can provide, revoke or update authorizations at any time using their own Direct address's server portal, such as server 102-3 illustrated in FIG. 1.

After the consent is obtained and entered into the server 102, the server 102 can transform this consent 134 into authorization records 136 and incorporate them into the entry 130 in server-local database 108 that is associated with the patient, linked with patient identifiers 125. For example, with continued reference to FIG. 2, server 102-4 copies this consent information 134 as an authorization record 136 to the entry 130 in a server-local database 108-4 that is associated with the patient linked with patient identifiers 125.

In one arrangement, each new or updated authorization record 136 is then replicated and transmitted to each of the affiliated entities identified in the entry 130 within server-local database 108, updating the entry 130 at each of the other server-local databases 108 associated with servers 102 that have been linked for that patient. For example, with continued reference to FIG. 2, server 102-4 identifies a linkage with entity 106-1 via the second address 128 in the entry 130 within server-local database 108-4. Server 102-4 copies and transmits the new authorization record 136 in the entry 130 within server-local database 108-4 to affiliated entity server 102-1 which then creates or updates that patient's authorization record 136 in the entry 130 in a server-local database 108-1.

After the entry 130 in database 108 identifies affiliated entities that have the patient's, or their legal representative's, authorization to release their patient records, automated secure consent-based routing of patient information ensues. In one arrangement, electronic patient records 132 can be pushed from one entity 106 to all affiliated, authorized entities 106, facilitated by their respective servers 102. For example, the server 102-4 can establish links, such as via an entry 130 in the database 108-4, to associate the patient identification information 125 with the patient care entities 106 identified by the authorization records 136. Accordingly, in the case where the patient has provided authorization within consent 134 to send the patient's electronic patient records 132 to the PCP entity 106-1, the server 102-4 can review the entry 130 in the server-local database 108-4 and, because of the consent-based linkage, can forward the patient records 132 to the PCP entity 106-1 via the PCP entity's server 102-1.

In one arrangement, electronic patient records 132 can be retrieved by one entity 106 from an affiliated, authorized entity 106, facilitated by their respective servers 102. Similar to the above example, the server 102-4 of the hospital facility 106-4 is aware of the PCP provider (i.e., server 102-1) based upon the entry 130 in the server-local database 108-4. Accordingly, when the hospital server 102-4 files authorization 136 into the entry 130 in the database 108-4 to authorize connection to that PCP provider server 102-1, the hospital server 102-4 also sends the authorization 136 to the referring PCP server 102-1. The PCP server 102-1 files authorization 136 into the entry 130 in its server-local database 108-1. As a result of this new authorization, PCP server 102-1 forwards the latest copy of clinical information (electronic patient records 132) to the hospital facility 106-4 via hospital server 102-4.

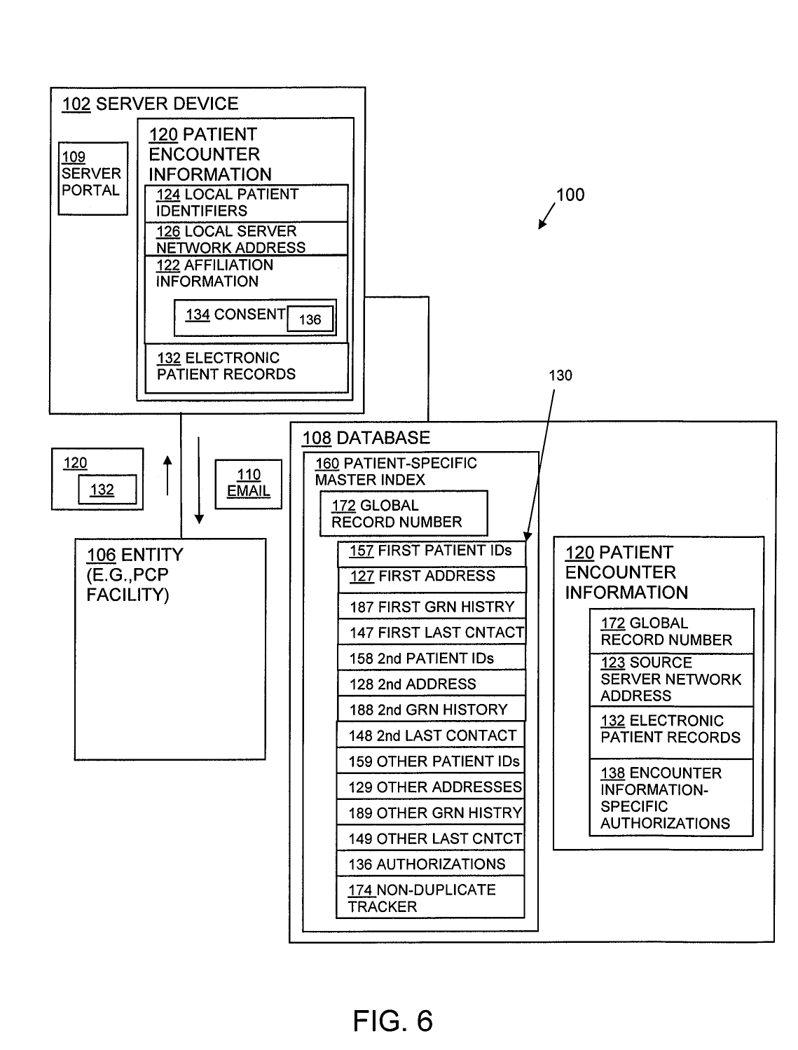

In one arrangement, when server 102 receives patient encounter information 120 from corresponding entity 106, copies of patient encounter information 120 can be stored in server local database 108 to facilitate response to future queries. For example, with reference to FIG. 6, when server 102 receives patient encounter information 120 from corresponding entity 106, the server 102 can copy some, or all, of patient encounter information 120, including electronic patient records 132, into server-local database 108. Each subsequent patient information 120 received by server 102 from corresponding entity 106 can create a new patient encounter information 120 entry in server-local database 108.

In one arrangement, when server 102 receives electronic patient records 132 from an affiliated entity's 106 corresponding server 102, copies of the electronic patient records 132 can be stored in server-local database 108 to facilitate response to future queries. For example, with reference to FIG. 6, when the server 102 receives electronic patient records 132 from an affiliated entity's 106 corresponding server 102, the local server 102 can create a patient encounter information 120 entry in server-local database 108 and copy some, or all, of the received the electronic patient records 132 into that patient encounter information 120 entry, including the source server network address 123 copied from the affiliated server's network address. Each subsequent electronic patient records 132 received by server 102 from an affiliated entity's 106 corresponding server 102 can create a new patient encounter information 120 entry in server-local database 108.

In one arrangement, the patient can provide detailed authorizations regarding the transfer of their electronic patient records 132, or parts thereof, corresponding to specific encounters. For example, the consent information 134 can identify which healthcare providers, facilities or entities can share various types of patient information with particular healthcare providers, facilities or entities, for particular purposes, and for particular time periods, from a specific encounter. To enable this functionality, with reference to FIG. 6, when server 102 receives a consent 134 which gives encounter-specific authorizations, the server 102 can copy the authorization into encounter information-specific authorizations 138 associated with that encounter's electronic patient records 132 within that patient encounter information 120 entry in server-local database 108. Any subsequent transfer of that encounter's electronic patient records 132 can be accompanied by the associated encounter information-specific authorizations 138.

Embodiments of the health information exchange system 100 automate obtaining patient consent and consent-enabled data routing among a variety of patient entities 106. In one arrangement, the health information exchange system 100 can be layered on top of existing HIEs. The health information exchange system 100 minimizes implementation burdens associated with local health care entities. Additionally electronic health records are exchanged only between entities that provide care to the patient, and only based on patient consent or legal requirements.

In order to identify a patient within a conventional healthcare system, the patient is typically assigned a Master Patient Index (MPI) number or Enterprise Master Patient Index (EMPI) number. For example, conventional systems include a centralized EMPI computer application that monitors new patient registrations at one or more entities, storing patient demographic information from each entity, affiliations, identifiers (including local medical record numbers), and the EMPI number for each patient in one central database. These centralized EMPIs enable mapping from one entity's medical record number (MRN) to another entity's MRN. In one arrangement, the health information exchange system 100 can be configured to provide a single enterprise patient identifier to the patient and mapping between each entity's MRN for the patient while minimizing the need for a conventional centralized EMPI.

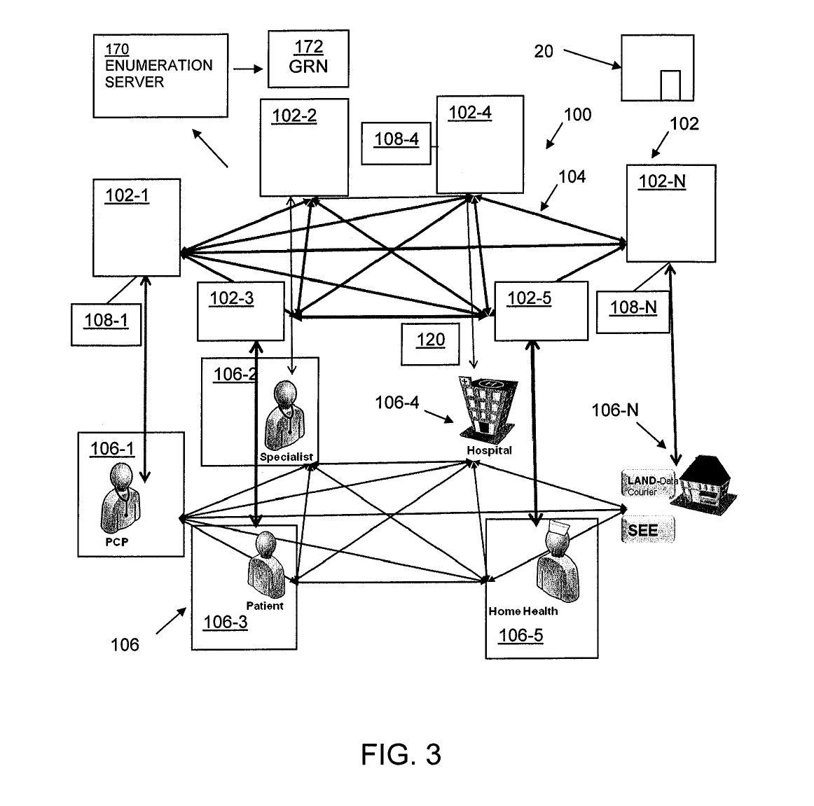

For example, with reference to FIG. 2, each server 102 can include local patient identifiers 124 which include a patient's local MRN and patient's locally-recorded demographic information (e.g., name, aliases, date of birth, gender, addresses, phone numbers, etc. from each patient encounter information 120 occurrence, such as a CCD or UTF, provided by its corresponding entity 106. Since most patient healthcare is initiated by an order or a referral from one healthcare provider to another (e.g. PCP to specialist, Extended Care Entity to ER, ER to PCP, hospital to Skilled Nursing Entity or Home Health Agency, etc.), each affiliation address 127, 128, and 129 recorded in the entry 130 in server-local database 108 can be used to facilitate mapping of local patient identifiers 124 between each of those providers' entities 106, both referring and referred-to. As shown in FIG. 3, a separate enumeration server 170, such as a Single ENumeration Server for Enterprise Indices (SENSED), can provide a unique global record number (GRN) 172 for each new patient that joins the health information exchange system 100, storing that GRN 172 in database 108 associated with server 102 corresponding to the entity 106 where the patient first seeks care. Exchanging local patient identifiers 124 and the GRN 172 with affiliated entities based on the linkages in entry 130, mapping these to the patient's affiliated providers' local patient identifiers 124, and then linking those identifiers to the patient's GRN 172 creates the ability to translate from one local MRN 124 to another entity's local MRN 124 without the need for a centralized EMPI. The resultant patient-specific master index or Segregated EMPI (SEMPI), with mapped local patient identifiers 124 and GRN 172, resides only within the databases 108 associated with servers 102 that correspond to each of the entities 106 that are affiliated with the patient. An example regarding the operation of the system 100 to provide a single enterprise patient identifier GRN 172 to the patient and mapping between each entity's MRN 124 for the patient is provided below.

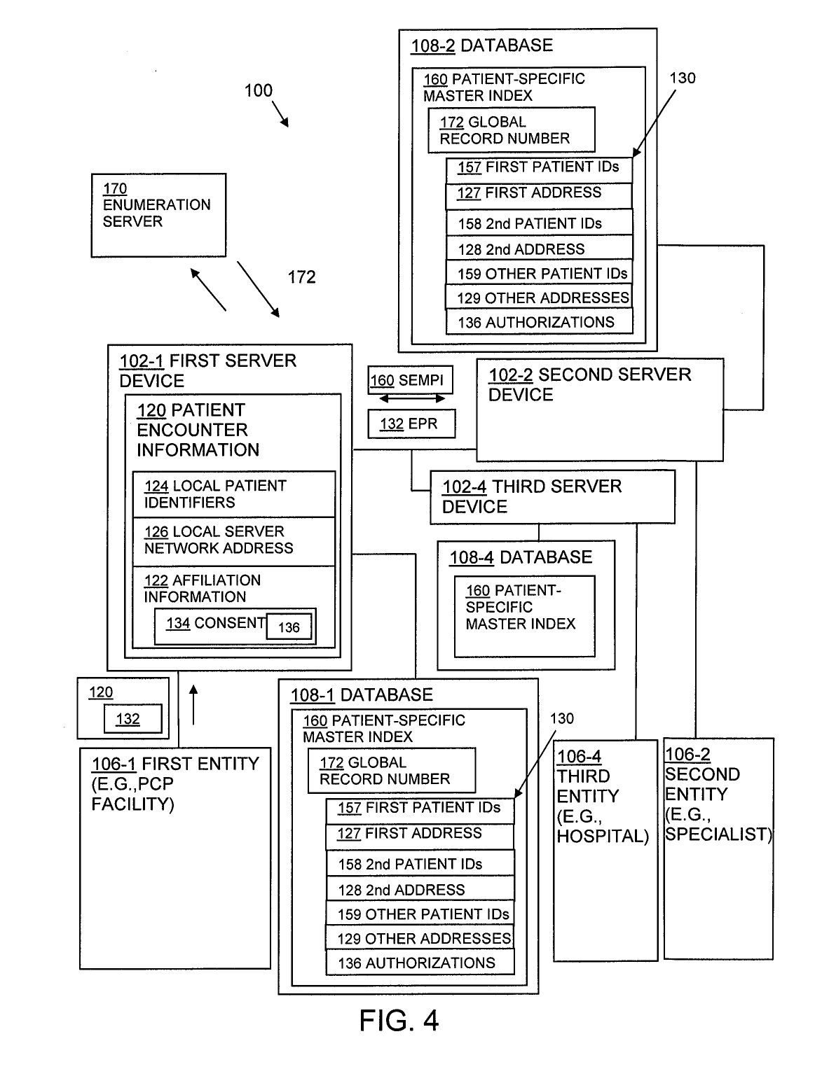

When a patient first encounters an entity 106 associated with system 100, a patient-specific master index or Segregated EMPI (SEMPI) entry 160 is created for the patient. With reference to FIG. 4, a new patient is first seen at an entity 106 (e.g., entity 106-1) and a variety of patient encounter information 120 (e.g., ADT) is transmitted to the corresponding local server 102 (e.g., server 102-1 associated with entity 106-1). The patient encounter information 120 contains local patient identifiers 124, including the patient's local MRN and the patient's local demographics (e.g., name, aliases, gender, date of birth, phone numbers, addresses, etc.), and local server address 126. The server 102 (e.g., 102-1) can identify an absence of an entry 130 in server-local database 108 (e.g. 108-1) with this new patient's local MRN as a patient identifier corresponding to local server address 126. As a result, server 102 (e.g. 102-1) creates a new patient-specific master index entry 160 in server-local database 108 (e.g. 108-1) for that patient. As part of this patient-specific master index entry 160, server 102 (e.g. 102-1) also creates the entry 130 with first patient identifiers 157 (e.g. MRN and local demographics from entity 106-1) and first address (e.g. address of local server 102-1). Since this is a new patient-specific master index entry 160 for this patient, the server 102 (e.g. 102-1) can then query the enumeration server 170 to obtain the next available global record number 172. In such an arrangement, the enumeration server 170 is configured to generate unique global record numbers 172 for the system 100. The requesting server 102 (e.g. 102-1) associates the newly generated and received global record number 172 with the patient's entry 130 within the patient's patient-specific master index entry 160 in server-local database 108 (e.g.108-1).

Newly identified entity affiliations for the patient cause the patient's patient-specific master index entry 160 to be copied to those new affiliates. With reference to FIG. 4, a new affiliated entity for a patient is conveyed as affiliation information 122 containing the affiliate's server 102 (e.g. 102-2) address within patient encounter information 120 (e.g. a referral or order) sent from an originating entity 106 (e.g., from entity 106-1) to the entity's local server 102 (e.g., server 102-1). Server 102 (e.g. 102-1) identifies that there is no address in the entry 130 in server-local database 108 (e.g. 108-1) with this affiliate's server 102 (e.g. 102-2) address associated with this patient's local MRN as a patient identifier corresponding to local server address 126. As a result, server 102 (e.g. 102-1) adds a second address 128 to the patient's entry 130 as part of the patient's patient-specific master index entry 160 in server-local database 108 (e.g. 108-1). Server 102 (e.g. 102-1) then sends a copy of the patient's patient-specific master index entry 160 from server-local database 108 (e.g. 108-1) to the newly identified affiliate's server 102 (e.g. 102-2) address.

The newly identified affiliate's server 102 (e.g. 102-2) evaluates the demographics within the patient identifiers (e.g. first patient identifiers 157) within the received copy of the patient's patient-specific master index entry 160, and determines utilizing a probabilistic patient-matching algorithm, whether there is already a patient-specific master index entry 160 within server-local database 108 (e.g. 108-2) for that patient. With no matches found, the affiliate's server 102 (e.g. 102-2) stores the copy of the patient's patient-specific master index entry 160 into server-local database 108 (e.g. 108-2). The affiliate's server 102 (e.g. 102-2) then queries the corresponding entity 106 (e.g. 106-2) with the patient's demographics within the patient identifiers (e.g. first patient identifiers 157) in order to retrieve the patient's existing and local demographics, or new local MRN. The affiliate's server 102 (e.g. 102-2) then stores this local MRN and any existing local demographics as patient identifiers (e.g. 158) in the entry 130 within the patient's patient-specific master index entry 160 in server-local database 108 (e.g. 108-2).

Updates with local data to a patient's patient-specific master index entry 160 are propagated to the other affiliated providers listed in the entry 130. With reference to FIG. 4, when a server 102 (e.g. 102-2) updates any local patient identifiers 124 (e.g. the local MRN or any local demographics in patient identifiers 158) in the entry 130 within the patient's patient-specific master index entry 160 in server-local database 108 (e.g. 108-2), the server 102 (e.g. 102-2) then sends a copy of the patient's updated patient-specific master index entry 160 from server-local database 108 (e.g. 108-2) to the other affiliates' server 102 (e.g. 102-1) addresses listed in the entry 130. When those servers 102 (e.g. 102-1) receive the patient's updated patient-specific master index entry 160 uniquely identified by global record number 172, those servers 102 (e.g. 102-1) reconcile the updated data (e.g. patient identifiers 158) with those already stored in the patient's updated patient-specific master index entry 160 within server-local database 108 (e.g. 108-1), and update the entries in server-local database 108 (e.g. 108-1).

Adding new affiliations updates a patient's existing patient-specific master index entry 160 and propagates changes to the other affiliated providers listed in the entry 130. With reference to FIG. 4, new affiliated entities for a patient are conveyed as affiliation information 122 containing the affiliate's server 102 (e.g. 102-4) address within patient encounter information 120 (e.g. a referral or order) sent from an originating entity 106 (e.g., from entity 106-1) to the entity's local server 102 (e.g., server 102-1). Server 102 (e.g. 102-1) identifies that there are no addresses in the entry 130 in server-local database 108 (e.g. 108-1) with this affiliate's server 102 (e.g. 102-2) address associated with this patient's local MRN as a patient identifier corresponding to local server address 126. As a result, server 102 (e.g. 102-1) adds additional addresses 129 to the patient's entry 130 as part of the patient's patient-specific master index entry 160 in server-local database 108 (e.g. 108-1).

Server 102 (e.g. 102-1) then sends a copy of the patient's patient-specific master index entry 160 from server-local database 108 (e.g. 108-1) to all of the affiliated providers' servers, including the newly identified affiliate's server 102 (e.g. 102-4). The newly identified affiliate's server 102 (e.g. 102-4) evaluates the addresses and patient identifiers, including demographics, (e.g. first patient identifiers 157 with address 127 and second patient identifiers 158 with address 128) within the received copy of the patient's patient-specific master index entry 160, and determines such as by utilizing a probabilistic patient-matching algorithm, whether there is already a patient-specific master index entry 160 within server-local database 108 (e.g. 108-4) for that patient.

With no matches found, the new affiliate's server 102 (e.g. 102-4) stores the copy of the patient's patient-specific master index entry 160 into server-local database 108 (e.g. 108-4). The new affiliate's server 102 (e.g. 102-4) then queries the corresponding entity 106 (e.g. 106-4) with the patient's demographics within the patient identifiers (e.g. first patient identifiers 157 and second patient identifiers 158) in order to retrieve the patient's existing and local demographics, or new local MRN. The new affiliate's server 102 (e.g. 102-4) then stores this local MRN and any existing local demographics as patient identifiers (e.g. 159) in the entry 130 within the patient's patient-specific master index entry 160 in server-local database 108 (e.g. 108-4). The new affiliate's server 102 (e.g. 102-4) can then send a copy of the patient's updated patient-specific master index entry 160 from server-local database 108 (e.g. 108-4) to the other affiliates' servers 102 (e.g. 102-1 and 102-2) addresses listed in the entry 130. When those servers 102 (e.g. 102-1 and 102-2) receive the patient's updated patient-specific master index entry 160 uniquely identified by global record number 172, those servers 102 (e.g. 102-1 and 102-2) reconcile the updated data (e.g. patient identifiers 158 and 159) with those already stored in the patient's updated patient-specific master index entry 160 within server-local database 108 (e.g. 108-1 and 108-2), and update the entries in server-local database 108 (e.g. 108-1 and 108-2).

It is possible for a patient to seek care at two or more entities in system 100 prior to affiliations between those entities being identified. In such a scenario, the patient will have created patient-specific master index entries 160 in each entity's server-local database 108, each with a different global record number 172. In one arrangement, these patient-specific master index entries 160 can be merged under a single global record number 172 with the maintenance of a merger audit trail so that they can be unmerged if merger was inappropriate.

With reference to FIG. 5, when new affiliated entities for a patient are added to the patient's entry 130 and server 102 (e.g. 102-1) then sends a copy of the patient's patient-specific master index entry 160 from server-local database 108 (e.g. 108-1) to all of the affiliated providers' servers, including the newly identified affiliate's server 102 (e.g. 102-4), it is possible that the newly identified affiliate's server 102 (e.g. 102-4) evaluates the patient's affiliate addresses and identifiers, including demographics, and determines, such as by utilizing a probabilistic patient-matching algorithm, that there is already a patient-specific master index entry 160 within server-local database 108 (e.g. 108-4) with a different previously assigned global record number 172 for that patient. Then the new affiliate's server 102 (e.g. 102-4) compares all of the patient identifiers (e.g. 157, 158 and 159) in the received patient-specific master index entry 160, such as by utilizing a probabilistic patient-matching algorithm, with all of the patient identifiers (e.g. 157, 158 and 159) in the patient's patient-specific master index entry 160 within server-local database 108 (e.g. 108-4) for corresponding addresses (e.g. 127, 128 and 129). If the patient identifiers are shown with a very high likelihood to be from the same person, then the new affiliate's server 102 (e.g. 102-4) adds the new identifiers and corresponding addresses and received global record number 172 into the local patient-specific master index entry's 160 patient identifiers (e.g. 159), addresses (e.g. 129) and global record number history (e.g. 189), respectively. Then the new affiliate's server 102 (e.g. 102-4) sends a copy of the patient's updated patient-specific master index entry 160 from server-local database 108 (e.g. 108-4) to all of the other affiliates' servers 102 (e.g. 102-1 and 102-2) addresses.

When those servers 102 (e.g. 102-1 and 102-2) receive the patient's updated patient-specific master index entry 160 they will update their patient's patient-specific master index entries 160 to reflect the merger with added affiliates, new global record number history, and possibly a new global record number 172 for that patient. If, on the other hand, the new affiliate's server 102 (e.g. 102-4) determined that there was insufficient confidence to match all of the patient identifiers as being from one patient, then a new patient-specific master index 160 entry is created in the server-local database 108 (e.g. 108-4), no merger takes place, and an email message 110 linked to the server portal 109 (e.g. 109-4) can be sent by the server 102 (e.g. 102-4) to the local entity letting them know that there may be a patient with two global record numbers 172. Similarly, if the new affiliate's server 102 (e.g. 102-4) determined that there is already more than one patient-specific master index 160 entry in the server-local database 108 (e.g. 108-4) that matches the patient identifiers and addresses received in the patient-specific master index 160, then a new patient-specific master index 160 entry is created in the server-local database 108 (e.g. 108-4), no merger takes place, and an email message 110 linked to the server portal 109 (e.g. 109-4) can be sent by the server 102 (e.g. 102-4) to the local entity letting them know that there may be a patient with two or more global record numbers 172. In one arrangement, when mergers of patient-specific master indices 160 do take place, server 102 (e.g. 102-4) that performed the merger can notify enumeration server 170 of the two global record numbers 172 that were merged. Enumeration server 170 would record these as merged global record number pairs 190. This would enable a system 100 to identify how many unique patients are in the system by counting each pair of global record numbers 172, identified as pairs in merged global record number pairs 190, as one.

In one arrangement, the system 100 can be used to facilitate the reconciliation of global record numbers 172. After an entity 106 is identified by system 100 as possibly having a patient with two or more global record numbers 172, an email can be sent to a designee at entity 106, including a URL hyperlink that accesses the corresponding local server's 102 server portal 109. Server portal 109 can allow the local entity's designee, with proper security, to view the contents of the patient's entry 130 stored in the patient's patient-specific master index 160 and the contents of the entries 130 stored in the patient-specific master indices 160 within server-local database 108 that may be duplicates. With proper security, the designee can utilize server portal 109 to allow the merger of two patient-specific master indices 160 to proceed. Similarly, with proper security, the designee can utilize server portal 109 to record that the entity 106 feels that two or more global record numbers 172 are not the same. With reference to FIG. 5, this information can be stored in non-duplicate tracker 174 in the patient's patient-specific master index 160 within server-local database 108, and used to suppress subsequent redundant notifications to an entity. In one arrangement, information stored about non-duplicate global record numbers 172 in non-duplicate tracker 174 can also be taken into account as part of the probabilistic patient-matching algorithm.

Duplicate local MRNs for the same patient can be commonly found within the EHRs of healthcare entities and facilities. There are two example scenarios where this can be identified by system 100. One example scenario occurs when a healthcare provider entity or facility identifies that it has two local MRNs for a given patient, the entity can then merge those records within their EHR which generates a “Merge” ADT message that is transmitted by the entity 106 to the entity's corresponding server 102. Another example occurs when updated demographics at entity 106 are sent to system 100 which recognizes that this patient's demographics now match demographics for a patient with a different MRN from the same entity. An example

Applicant: Garber, Lawrence David regarding the operation of the system 100 to resolve patient identifiers in a patient-specific master index 160 in situations where an entity or facility has two or more MRNs for an individual patient is provided below.

Duplicate local MRNs for the same patient can be identified and corrected by a healthcare provider entity or facility, and in response, system 100 can automatically merge duplicate patient-specific master index entries 160. With reference to FIG. 5, when entity 106 (e.g. 106-1) identifies that one of their patients had been assigned two different local MRNs and thus merge those records within their EHR, a “Merge” ADT message is typically generated from the EHR which is transmitted by the entity 106 (e.g. 106-1) to the entity's corresponding merging entity's server 102 (e.g. 102-1), identifying the duplicate local MRN that is being merged into the primary MRN for the patient. The merging entity's server 102 (e.g. 102-1) would identify the two patient-specific master index entries 160 within server-local database 108 (e.g. 108-1) corresponding to the duplicate local MRN and primary MRN for the patient. The merging entity's server 102 (e.g. 102-1) would then compare all of the patient identifiers (e.g. 157, 158 and 159) in the duplicate local MRN patient's patient-specific master index entry 160, such as by utilizing a probabilistic patient-matching algorithm, with all of the patient identifiers (e.g. 157, 158 and 159) in the primary MRN patient's patient-specific master index entry 160 within server-local database 108 (e.g. 108-1) for corresponding addresses (e.g. 127, 128 and 129).

If the patient identifiers are shown with a very high likelihood to indeed be from the same person, then merging entity's server 102 (e.g. 102-1) adds the duplicate local MRN patient's identifiers and corresponding addresses and global record number 172 into the primary MRN patient's patient-specific master index entry's 160 patient identifiers (e.g. 159), addresses (e.g. 129) and global record number history (e.g. 189), respectively. Then merging entity's server 102 (e.g. 102-1) sends a copy of the patient's updated patient-specific master index entry 160 from server-local database 108 (e.g. 108-1) to all of the other affiliates' servers 102 (e.g. 102-2 and 102-4) addresses. When those servers 102 (e.g. 102-2 and 102-4) receive the patient's updated patient-specific master index entry 160 they will update their patient's patient-specific master index entries 160 to reflect the merger with added affiliates, new global record number history, and possibly a new global record number 172 for that patient. If, on the other hand, the merging entity's server 102 (e.g. 102-1) determines that there was insufficient confidence to match all of the patient identifiers as being from one patient, then no merger takes place, and an email message 110 linked to the server portal 109 (e.g. 109-1) can be sent by the merging entity's server 102 (e.g. 102-1) to the local entity letting them know that they should verify the appropriateness of the merger.

Duplicate local MRNs for the same patient at a given entity 106 can also be identified by system 100 when updated patient demographic information is sent from entity 106 to its corresponding server 102, or when updated patient-specific master index entries 160 are sent from one entity to another. Examples for each of these scenarios are provided below.

Duplicate local MRNs for the same patient at a given entity 106 can also be identified by system 100 when updated patient demographic information is sent from entity 106 to its corresponding server 102. With reference to FIG. 5, when entity 106 (e.g. 106-1) updates a patient's demographic information (e.g. last name change when a patient gets married), patient encounter information 120 of the ADT variety is transmitted by the entity 106 (e.g. 106-1) to the corresponding entity's server 102 (e.g. 102-1), identifying the local MRN for the patient along with their new demographics. The entity's server 102 (e.g. 102-1) uses these demographics to update the patient identifiers (e.g. 158) in an entry 130 within the patient's patient-specific master index entry 160 in server-local database 108 (e.g. 108-1). In one arrangement, the entity's server 102 (e.g. 102-1) always determines if newly-received patient demographic updates also match a patient-specific master index entry 160 that has a different global record number 172. In one arrangement, when receiving those updates to the patient-specific master index entry 160 within server-local database 108 (e.g. 108-1) that has the same global record number 172, the affiliated entity's server 102 (e.g. 102-1) searches through all of the other patient-specific master index entries 160 within server-local database 108 (e.g. 108-1) doing a comparison, such as by utilizing a probabilistic patient-matching algorithm, between the updated patient identifiers 124 from local server's 102 (e.g. 102-1) address 126 and local patient identifiers (e.g. 157, 158 or 159) found in any local entry 130 that has the same address (e.g. in 127, 128 or 129) as local server's 102 (e.g. 102-1) address 126. If a match is found with a very high likelihood to indeed be from the same person, then a likely duplicate MRN for a patient has been found within local entity 106 (e.g. 106-1), along with a duplicate patient-specific master index entry 160 for that patient. In such a case, local server 102 (e.g. 102-1) sends an email message 110 linked to the local server portal 109 (e.g. 109-1) to the local entity 106 (e.g. 106-1) letting them know that a specific patient likely has two local MRNs assigned to them.

Duplicate local MRNs for the same patient at a given entity 106 can also be identified by system 100 when updated patient-specific master index entries 160 are sent from one entity to another. With reference to FIG. 5, when entity 106 (e.g. 106-4) updates a patient's demographic information (e.g. last name change when a patient gets married), patient encounter information 120 of the ADT variety is transmitted by the entity 106 (e.g. 106-4) to the corresponding entity's server 102 (e.g. 102-4), identifying the local MRN for the patient along with their new demographics. The entity's server 102 (e.g. 102-4) uses these demographics to update the patient identifiers (e.g. 158) in the entry 130 within the patient's patient-specific master index entry 160 in server-local database 108 (e.g. 108-4). Then the entity's server 102 (e.g. 102-4) sends a copy of the patient's updated patient-specific master index entry 160 from server-local database 108 (e.g. 108-4) to the other affiliates' servers 102 (e.g. 102-1 and 102-2) addresses listed in the entry 130.

In one arrangement, the affiliated entity's server 102 (e.g. 102-1) determines if newly-received patient demographic updates also match a patient-specific master index entry 160 that has a different global record number 172. It does this by first identifying which affiliated entity had updated demographics. In one arrangement, updates are identified as a result of servers 102 (e.g. 102-4) recording the date and time (i.e. “timestamp”) that each entry within the entry 130 was updated, and the affiliated entity's server 102 (e.g. 102-1) comparing the timestamps in the received patient-specific master index entry 160 with those in the patient-specific master index entry 160 within server-local database 108 (e.g. 108-1) that has the same global record number 172. Entries within the received patient-specific master index entry 160 that have a more recent timestamp than those within server-local database 108 (e.g. 108-1) are considered to be updates. In one arrangement, when receiving those updates to the patient-specific master index entry 160 within server-local database 108 (e.g. 108-1) that has the same global record number 172, the affiliated entity's server 102 (e.g. 102-1) searches through all of the other patient-specific master index entries 160 within server-local database 108 (e.g. 108-1) doing a comparison, such as by utilizing a probabilistic patient-matching algorithm, between the updated patient identifiers (e.g. 158) and local patient identifiers (e.g. 157, 158 or 159) found in any local entry 130 that has the same address (e.g. in 127, 128 or 129) as local server's 102 (e.g. 102-1) address 126. If a match is found with a very high likelihood to indeed be from the same person, then a likely duplicate MRN for a patient has been found within local entity 106 (e.g. 106-1), along with a duplicate patient-specific master index entry 160 for that patient. In such a case, local server 102 (e.g. 102-1) sends an email message 110 linked to the local server portal 109 (e.g. 109-1) to the local entity 106 (e.g. 106-1) letting them know that a specific patient likely has two local MRNs assigned to them.

While mergers of patient records and their associated local MRNs typically take place in the local EHRs of an entity 106, in one arrangement the configuration system 100 can be used to facilitate that process. For example, after an entity 106 is identified by system 100 as likely having a patient with two MRNs, an email can be sent to a designee at entity 106, including a URL hyperlink that accesses the corresponding local server's 102 server portal 109. Server portal 109 can allow the local entity's designee, with proper security, to view the contents of the patient's entry 130 stored in the patient's patient-specific master index 160 within server-local database 108. With proper security, the designee can utilize server portal 109 to record that the entity 106 feels that two or local medical numbers in patient identifiers (e.g. 157, 158 or 159) are not the same. With continued reference to FIG. 5, this information can be stored in non-duplicate tracker 174 in the patient's patient-specific master index 160 within server-local database 108, and used to suppress subsequent redundant notifications to an entity. In one arrangement, information stored about non-duplicate local medical numbers in non-duplicate tracker 174 can also be taken into account as part of the probabilistic patient-matching algorithm.

A single MRN assigned to two different patients is another issue seen within conventional EHRs of healthcare entities and facilities. In the present system 100, with reference to FIG. 5, utilizing global record number history (e.g. 187, 188 and 189) associated with each local MRN stored as a patient identifier (e.g. 157, 158 and 159) and address (e.g. 127, 128 and 129) in a patient's patient-specific master index 160 within server-local database 108, local servers 102 will facilitate unmerging patient-specific master indexes 160 automatically in most cases, and leaving an audit trail in the event that the records need to be re-merged. For example, for a relatively convoluted case, email message 110 linked to the server portals 109 can be sent to the appropriate designees at the affected provider entities in order to sort-out the appropriate un-merger of the records. It should be noted that, in such a case, to enable unmerging, each clinical data element includes a provider entity source. In one arrangement, with reference to FIG. 6, each electronic patient record 132 from patient encounter information 120 stored in server-local database 108 is associated with the information's source server network address 123 in order to identify the source of each clinical data element.

A single global record number 172 assigned to two different patients might occur in system 100. In the present system 100, with reference to FIG. 5, utilizing global record number history (e.g. 187, 188 and 189) associated with patient identifiers (e.g. 157, 158 and 159) and addresses (e.g. 127, 128 and 129) in a patient's patient-specific master index 160 within server-local database 108, local servers 102 can facilitate unmerging patient-specific master indexes 160 automatically in most cases, and leaving an audit trail in the event that the records need to be re-merged. For relatively convoluted cases, email message 110 linked to the server portals 109 can be sent to the appropriate designees at the affected provider entities in order to sort-out the appropriate un-merger of the records.

In one arrangement, when server 102 receives patient encounter information 120 from corresponding entity 106, copies of patient encounter information 120 can be stored in server local database 108 indexed by the patient's global record number 172 to facilitate a rapid response to future queries. With reference to FIG. 6, when server 102 receives patient encounter information 120 from corresponding entity 106, the server 102 can use the local patient identifiers 124 and local server network address 126 within patient encounter information 120 to query all of the patient identifiers (e.g. 157, 158 and 159) and their corresponding address (e.g. 127, 128, and 129) in entry 130 to determine, such as by utilizing a probabilistic patient-matching algorithm, which entry 130 in server-local database 108 belongs to that patient. Server 102 can then copy some, or all, of patient encounter information 120, including electronic patient records 132, into server-local database 108. The server 102 is also configured to populate in patient encounter information 120 within server-local database 108, the patient's global record number 172 identified in the patient's patient-specific master index 160, and the source server network address 123 copied from local server network address 126. Each subsequent patient information 120 received by server 102 from corresponding entity 106 can cause the creation of a new patient encounter information 120 entry in server-local database 108. When server 102 is queried in the future regarding electronic patient records 132 for the patient with global record number 172, all of the patient's patient encounter information 120 can readily be identified using the global record number 172 stored within each patient encounter information 120 in server-local database 108.

In one arrangement, when server 102 receives electronic patient records 132 from an affiliated entity's 106 corresponding server 102, copies of the electronic patient records 132 can be stored in server-local database 108 indexed by the patient's global record number 172 to facilitate a rapid response to future queries. With reference to FIG. 6, when server 102 receives electronic patient records 132 and global record number 172 from an affiliated entity's 106 corresponding server 102, server 102 can create a patient encounter information 120 entry in server-local database 108, including the received electronic patient records 132, the received patient's global record number 172, and the source server network address 123 copied from affiliated server's 102 network address. Each subsequent electronic patient records 132 received by server 102 from an affiliated entity's 106 corresponding server 102 can create a new patient encounter information 120 entry in server-local database 108. When the server 102 is queried in the future regarding electronic patient records 132 for the patient with global record number 172, all of the patient's patient encounter information 120 can readily be identified using the global record number 172 stored within each patient encounter information 120 in server-local database 108.

In one arrangement, each server 102 is configured to automatically synchronize its clinical information with the other servers 102 that are associated with entities 106 that have been authorized by the patient as recorded in authorization 136 within entry 130 in the server-local database 108. For example, servers 102 can utilize a publish/subscribe model where each entity 106 is publishing electronic patient records 132 to their associated secure server (i.e., VIP mailbox) 102, and other entities 106 can subscribe to receive any new or updated electronic patient records on their patients, with the patient's authorization, via those other entities' corresponding servers 102. In one arrangement, entities 106 can specify, via their corresponding servers 102, the types of information to which they wish to subscribe. In one arrangement, new or updated electronic patient records 132 can be sent to all patient-authorized affiliated entities 106 via their corresponding server 102, regardless of whether or not they subscribed to that data. In one arrangement, the server 102 that receives those updated electronic patient records 132 and the patient's global record number 172 from other servers 102 can use the patient's patient-specific index 160 to identify the local entity's 106 patient identifiers (e.g. 157, 158, or 159), including local medical record number, and send those along with the electronic patient records 132 in order to facilitate filing into entity's 106 electronic health record system.

In one arrangement, rules incorporated into the servers or VIP mailboxes 102 can push electronic patient records, retrieve electronic patient records, and synchronize electronic patient recordsamong patient-authorized providers,. Additionally, these rules can also be used to synchronize patient-level information, including immunization status, Advance Directives, and Longitudinal Care Plans (e.g. health concerns, goals, interventions, assessment, outcomes, and treatment team roles and responsibilities).

Additionally, in one arrangement, a server 102 can be configured to synchronize information and perform arithmetic and/or logical operations on that information. For example, a patient's lifetime radiation exposure can be tallied by a server 102 based upon the automatic synchronization of reports or claims from x-ray studies performed on the patient at each entity 106.

Since the server 102 is configured to receive all ADT messages 120, in one arrangement, rules can also be created to disseminate notification of changes in patient status, including arrivals, admissions, discharges, deaths, change in PCP, or activation of a healthcare proxy. In one configuration, server 102 can use this information to keep a chronological record of where the patient's physical location was (e.g. inpatient, ED, or outpatient) over time.

The rules built into the servers 102 can be configured to take advantage of other streams of clinical information coming from corresponding entity 106 and route specific clinical information to meet local, state or federal regulations, such as routing immunizations, reportable diseases, and syndromic surveillance data automatically to the Department of Public Health.

Since server 102 rules would be definable by the HIE, in one arrangement, changes to reporting and routing requirements could automatically be propagated and instantly put into effect, for example, when a new reportable disease is defined or a new parameter is needed by the Department of Public Health for syndromic surveillance. This is relatively easier than requiring each healthcare entity to change their internal monitoring and reporting processes. Similarly, patient-matching algorithms could be tuned and updated simultaneously to all of servers 102.

With the automation of information flow to entities, there lies a risk that excessive information will be sent to EHR mailboxes. Local server 102 can provide the ability to control the types of information that are sent to their corresponding entity's 106 EHR, as well as apply entity-specific rules to determine which documents should be sent to EHR mailboxes versus filing silently into the EHR. For example, these rules can take into account which entity ordered a test/procedure/encounter, which entity performed a test/procedure/encounter, the credentials and role of the person who performed a test/procedure/encounter, where the patient was located (e.g. inpatient, ED, or outpatient) when the test/procedure/encounter was performed, where the patient was located (e.g. inpatient, ED, or outpatient) when the test/procedure/encounter results became available, test/procedure/encounter abnormality-related flags, and the type of document.

As indicated above, when a server 102 receives a new document such as patient encounter information 120 from a local entity 106, the server 102 transmits copies to other authorized servers 102 and providers 106 based on consents stored in the patient-specific master index 160. In one arrangement, such transmittal is filtered based upon the patient's last provider or entity contact date. For example with reference to FIG. 6, based on an ADT message from entity 106 to corresponding server 102, the patient's last entity or facility contact date (e.g. 147, 148 or 149) is maintained in the patient-specific master index 160 and synchronized with the patient's patient-specific master indexes 160 at other affiliated entities. In response to receiving new patient encounter information 120, if the server 102 detects an absence of patient contact with an otherwise authorized entity for more than one year, for example, the server 102 withholds of electronic patient records 132 from being sent to that server and entity in the system 100. In the case where the server 102 subsequently detects an updated contact date with the patient at that other entity, the server 102 can resume transmittal of electronic patient records 132, and in one configuration, send temporarily withheld electronic patient records 132.

Synchronization or sending of health care information, such as electronic healthcare records, among the servers 102 before it is needed can provide a variety of benefits. For example, the synchronization can trigger alerts for the recipient entity, such as “Your patient John Smith has just arrived in the ER.” Additionally, when the patient calls a entity 106, such as a specialist in advance of a follow-up visit, up to date (i.e., synchronized) information already resides at the entity. Accordingly, clinical decision support systems can work properly and minimize false positive or false negative alerts.

In one arrangement, the patient-specific master index 160 can be enhanced to accommodate de-identified data aggregation. For example, as illustrated in FIG. 4, each patient has a unique global record number 172 for the system 100. Accordingly, when there is a need to send de-identified data to, for example, a quality data center for quality reporting, a server 102 can remove the Health Insurance Portability and Accountability Act of 1996 (HIPAA) protected health information (PHI) identifiers from the data being sent, but the global record number 172 can be included with the de-identified data. As a result, data on the same patient from multiple sources such as a hospital, a specialist, and the PCP could be merged, for example in the quality data center, using the global record numbers 172.

In one arrangement, with reference to FIG. 5, the automated health information exchange system 100 is also configured to receive distributed queries 115 from a server 102 corresponding to an authorized entity 106 in order to allow an evaluation of population health. Such queries 115 would be sent to all servers 102. Since patients have redundant data in all of a patient's authorized affiliated entities' 106 corresponding servers 102, such distributed queries 115 should be targeted at specific entities for each patient to minimize unnecessary work and duplicate results. In one arrangement, servers 102 only perform queries on patients where their local server address 126 is either found in first address 127 or the local server 102 is not authorized to share its data with the entity identified in first address 127 within the entry 130 in the patient's patient-specific master index 160 in server-local database 108.

In one arrangement, the automated health information exchange system 100 is also configured to receive distributed queries 115 from a server 102 corresponding to an authorized entity 106, in order to look for the presence of specific information on a specific patient. Such queries 115, including patient identifiers such as demographic information, and the distributed query criteria for a positive response, can be sent to all servers 102 in system 100, and the positive responses can be used for real-time decision making, such as determining whether a gun applicant has a disqualifying medical condition. In one arrangement and with reference to FIG. 6, upon receipt of the distributed query, each server 102 evaluates all of the patient identifiers (e.g. 157, 158 and 159) in entry 130 and determines, such as by utilizing a probabilistic patient-matching algorithm, whether there is a patient-specific master index entry 160 within server-local database 108 for that patient. If the patient identifiers are shown with a relatively high likelihood to be from the same person, then server 102 uses the global record number 172 in that patient-specific master index entry 160 to query electronic patient records 132 with the same corresponding global record number 172 in patient encounter information 120, and determine whether the distributed query criteria are true for any of the patient's electronic patient records 132 within server-local database 108. In one arrangement, queries can be limited to those patient encounter information 120 records where the source server network address 123 matches the local server's 102 local server network address 126.

Following local server's 102 evaluation of a patient-specific distributed query, if any of the patient's electronic patient records 132 within server-local database 108 satisfy the distributed query criteria, then local server 102 would send a positive response, such as a “True” or in one configuration, the actual electronic patient records 132 that satisfied the distributed query criteria, back to the initial querying server 102. In one configuration, if none of the patient's electronic patient records 132 within server-local database 108 satisfy the distributed query criteria, then server 102 would send a negative response, such as “False”, back to the initial querying server 102.

The use of a patient-specific master index 160 allows for patient identification within the automated health information exchange system 100 while minimizing or eliminating the need for a central EMPI. Additionally electronic patient records 132 are exchanged only between entities that provide care to the patient based upon the patient-specific master index 160. The system 100 is highly scalable and economically sustainable due to low operating expense resulting in part from the lack of necessity for a central staff to maintain an EMPI.

While various embodiments of the invention have been particularly shown and described, it will be understood by those skilled in the art that various changes in form and details may be made therein without departing from the spirit and scope of the invention as defined by the appended claims.

What is claimed is:

1. In a server device associated with a first patient care entity of a group of patient care entities, a method for associating electronic patient records among the patient care entities, comprising:
receiving, by the server associated with the first patient care entity, patient encounter information associated with a patient of the first patient care entity;
reviewing, by the server associated with the first patient care entity, affiliation information of the patient encounter information, the affiliation information identifying the patient's affiliation with one or more second patient care entities of the group of patient care entities; and
establishing, by the server associated with the first patient care entity, a link with each of the identified one or more second patient care entities of the group of patient care entities based upon the affiliation information, the link identifying an association between the first patient care entity and the one or more second patient care entities for the patient.

2. The method of claim 1, further comprising at least one of sending, by the server associated with the first patient care entity, the patient's electronic patient records, received from the first patient care entity, to the identified one or more second patient care entities of the group of patient care entities based upon the link, and receiving, by the server associated with the first patient care entity, the patient's electronic patient records from the identified one or more second patient care entities of the group of patient care entities based upon the link with subsequent forwarding of the patient's electronic patient records to the first patient care entity.

3. The method of claim 1, wherein:
reviewing affiliation information of the patient encounter information includes reviewing, by the server associated with the first patient care entity, consent information associated with the patient of the first patient care entity, the consent information identifying a subset of the one or more second patient care entities of the group of patient care entities as an authorized recipient of the patient's electronic patient records;
associating, by the server associated with the first patient care entity, authorizations with the links for each of the identified one or more second patient care entities;
sending, by the server associated with the first patient care entity, the patient's authorizations associated with the consent to the identified one or more second patient care entities of the group of patient care entities based upon the established links; and
sending, by the server associated with the first patient care entity, the patient's electronic patient records to the authorized one or more second patient care entities of the group of patient care entities based upon the established links and associated authorizations.

4. The method of claim 1, wherein establishing the link with each of the identified one or more second patient care entities comprises associating, by the server associated with the first patient care entity, the patient identifiers with a network address of the server associated with the first patient care entity and with the network address of the server associated with the one or more second patient care entities.

5. The method of claim 4, comprising:
receiving, by the server associated with the first patient care entity, electronic patient records of the patient, identified by the patent identifiers, from the first patient care entity; and
automatically forwarding, by the server associated with the first patient care entity, at least a portion of the electronic patient records to the network address of the server associated with the one or more second patient care entities based upon the established links and authorizations.

6. The method of claim 1, comprising receiving, by the server associated with the first patient care entity, initial patient encounter information associated with a patient of the first patient care entity, and generating, by the server associated with the first patient care entity, a patient-specific master index that associates at least one patient identifier of the patient at the first patient care entity with pat least one of a patient identifier, link, and authorizations for the patient at the one or more second patient care entities.

7. The method of claim 6, comprising associating, by the server associated with the first patient care entity, a unique global record number to the patient-specific master index.

8. The method of claim 6, wherein:
receiving, by the server associated with the first patient care entity, from at least one of the first patient care entity and a server device of the second patient care entity, at least one of updated patient identifiers, authorizations, and affiliation information;
updating, by the server associated with the first patient care entity, the patient-specific master index with the at least one of updated patient identifiers, authorizations, and affiliation information; and
sending, by the server associated with the first patient care entity, the updated patient-specific master index to the one or more second patient care entities of the group of patient care entities based upon the established links.

9. The method of claim 6, comprising:
receiving, by the server associated with the first patient care entity, a patient-specific master index for a patient;
detecting, by the server associated with the first patient care entity, a correspondence between patient identifiers associated with the received patient-specific master index and patient identifiers associated with pre-existing patient-specific master indices;
in response to detecting the correspondence, merging, by the server associated with the first patient care entity, the received patient-specific master index and the pre-existing patient-specific master index; and
in response to detecting an absence of a correspondence, storing, by the server associated with the first patient care entity, the received patient-specific master index.

10. The method of claim 6, comprising:
receiving, by the server associated with the first patient care entity, electronic patient records and the global record number associated with the patient;
mapping, by the server associated with the first patient care entity, the received global record number to the first patient care entity's patient identifiers, including medical record number, using the patient-specific master index; and
forwarding, by the server associated with the first patient care entity, the patient's electronic patient records and first patient care entity's patient identifiers to the first patient care entity.

11. The method of claim 6, comprising:
receiving, by the server associated with the first patient care entity, from at least one of the first patient care entity or a second patient care entity's server, patient encounter information or a patient-specific master index;
detecting, by the server associated with the first patient care entity, two or more patients as assigned a single medical record number from the same entity, or a single global record number; and
unmerging, by the server associated with the first patient care entity, the patient-specific master indices and patient identifiers for the patient.

12. The method of claim 6, comprising:
receiving, by the server associated with the first patient care entity, from a second patient care entity's server, a query for patient-specific or population-specific information;
determining, by the server associated with the first patient care entity, based on the patient-specific master index, whether the query should be performed on that patient in order to minimize redundant queries and responses across the group of patient care entities;
detecting, by the server associated with the first patient care entity, patients who satisfy the criteria of the query of their electronic patient records; and
sending, by the server associated with the first patient care entity, a response to the querying server, of the resultant information regarding the one or more patients identified by the query.

13. A server device associated with a first patient care entity of a group of patient care entities comprising:
a controller configured to:
receive patient encounter information associated with a patient of the first patient care entity;
review affiliation information of the patient encounter information, the affiliation information identifying the patient's affiliation with one or more second patient care entities of the group of patient care entities; and
establish a link with each of the identified one or more second patient care entities of the group of patient care entities based upon the affiliation information, the link identifying an association between the first patient care entity and the one or more second patient care entities for the patient.

14. The server device of claim 13, wherein the controller is further configured to send the patient's electronic patient records, received from the first patient care entity, to the identified one or more second patient care entities of the group of patient care entities based upon the link, and receive the patient's electronic patient records from the identified one or more second patient care entities of the group of patient care entities based upon the link with subsequent forwarding of the patient's electronic patient records to the first patient care entity.

15. The server device of claim 13, wherein the controller is configured to:
when reviewing affiliation information of the patient encounter information, review consent information associated with the patient of the first patient care entity, the consent information identifying a subset of the one or more second patient care entities of the group of patient care entities as an authorized recipient of the patient's electronic health records;
associate authorizations with the links for each of the identified one or more second patient care entities;
send the patient's authorizations associated with the consent to the identified one or more second patient care entities of the group of patient care entities based upon the established links; and
send the patient's electronic patient records to the authorized one or more second patient care entities of the group of patient care entities based upon the established links and associated authorizations.

16. The server device of claim 13, wherein the controller is configured to, when establishing the link with each of the identified one or more second patient care entities, associate the patient identifiers with a network address of the server associated with the first patient care entity and with the network address of the server associated with the one or more second patient care entities.

17. The server device of claim 16, wherein the controller is configured to:
receive electronic patient records of the patient, identified by the patent identifier, from the first patient care entity; and
automatically forward the at least a portion of the electronic patient records to the network address of the server associated with the one or more second patient care entities based upon the established links and authorizations.

18. The server device of claim 13, wherein the controller is configured to receive initial patient encounter information associated with a patient of the first patient care entity, and generating, by the server associated with the first patient care entity, a patient-specific master index that associates at least one patient identifier of the patient at the first patient care entity with pat least one of a patient identifier, link, and authorizations for the patient at the one or more second patient care entities.

19. The server device of claim 18, comprising associating a unique global record number to the patient-specific master index.

20. The server device of claim 18, wherein the controller is configured to:
receive from at least one of the first patient care entity and a server device of the second patient care entity, at least one of updated patient identifiers, authorizations, and affiliation information;
update the patient-specific master index with the at least one of updated patient identifiers, authorizations, and affiliation information; and
send the updated patient-specific master index to the one or more second patient care entities of the group of patient care entities based upon the established links.

21. The server device of claim 18, wherein the controller is configured to:
receive a patient-specific master index for a patient;
detect a correspondence between patient identifiers associated with the received patient-specific master index and patient identifiers associated with pre-existing patient-specific master indices;
in response to detecting the correspondence, merge the received patient-specific master index and the pre-existing patient-specific master index; and
in response to detecting an absence of a correspondence, store the received patient-specific master index.

22. The server device of claim 18, wherein the controller is configured to:
receive electronic patient records and the global record number associated with the patient;
map the received global record number to the first patient care entity's patient identifiers, including medical record number, using the patient-specific master index; and
forward the patient's electronic patient records and first patient care entity's patient identifiers to the first patient care entity.

23. The server device of claim 18, wherein the controller is configured to:
receive from at least one of the first patient care entity or a second patient care entity's server, patient encounter information or a patient-specific master index;
detect two or more patients as assigned a single medical record number from the same entity, or a single global record number; and
unmerge the patient-specific master indices and patient identifiers for the patient.

24. The server device of claim 18, wherein the controller is configured to:
receive from a second patient care entity's server, a query for patient-specific or population-specific information;
determine based on the patient-specific master index, whether the query should be performed on that patient in order to minimize redundant queries and responses across the group of patient care entities;
detect patients who satisfy the criteria of the query of their electronic patient records; and
send a response to the querying server, of the resultant information regarding the one or more patients identified by the query.

25. A computer program product having a non-transient computer-readable medium including computer program logic encoded thereon that, when performed by a controller of a server device associated with a first patient care entity of a group of patient care entities causes the controller to:
receive patient encounter information associated with a patient of the first patient care entity;
review affiliation information of the patient encounter information, the affiliation information identifying the patient's affiliation with one or more second patient care entities of the group of patient care entities; and
establish a link with each of the identified one or more second patient care entities of the group of patient care entities based upon the affiliation information, the link identifying an association between the first patient care entity and the one or more second patient care entities for the patient.
